(19) United States
(12) Patent Application Publication
(10) Pub. No.: US 2009/0030156 A1
(43) Pub. Date: Jan. 29, 2009

(54) PROCESS FOR PRODUCING SPECIAL-GRADE NATURAL RUBBER

(76) Inventor: Ploenpit Boochathum, Bangkok (TH)

Correspondence Address: PARK LAW FIRM, 3255 WILSHIRE BLVD, SUITE 1110, LOS ANGELES, CA, 90010, US

(21) Appl. No.: 12/144,483

(22) Filed: Jun. 23, 2008

(30) Foreign Application Priority Data
May 16, 2007 (TH) 0701002408

(51) Int. Cl. C08F 8/06

(52) U.S. Cl. 525/388

(57) ABSTRACT

The purity, molecular weight and other properties of natural rubber are controlled using the process of in situ ozonolysis reaction. The process further comprises a step of removing impurities from natural rubber latex by using a separator prior to the in situ ozonolysis reaction process, and a step of removing water from the modified natural rubber by using a coagulant, formic acid or acetic acid subsequent to the in situ ozonolysis reaction process.

### RELATED FOREIGN APPLICATION

This application is based on patent applications filed in Thailand with the filing date of May 16, 2007 with the patent application number 0701002408 by the applicant, the contents of which are incorporated by reference into this disclosure as if fully set forth herein.

### BACKGROUND OF THE INVENTION

This invention relates to the field of natural rubber processing. More specifically, this invention relates to the field of polymer science and technology in which natural rubber latex is processed in an in situ ozonolysis reaction in order to control the purity, molecular weight and other properties of natural rubber.

It is well known that natural rubber is widely used as raw material for the production of various kinds of rubber products. However, there are many limitations to the conventional methods of processing natural rubber, such as higher than desired impurity, inconsistency, molecular weight, viscosity and contamination of other chemicals and metal ions. Conventional methods of processing natural rubber products, in general, require a step of mastication or milling of natural rubber to soften the rubber and lower its viscosity before chemicals and additives are mixed. Mastication of natural rubber consumes scarce energy and resources.

### SUMMARY OF THE INVENTION

The present invention contrives to solve the disadvantages of the prior art.

An objective of the invention is to provide a controllable molecular weight of natural rubber.

Another objective of the invention is to provide the consistency of the natural rubber properties.

In order to achieve the above objectives, the present invention provides a process of producing special-grade natural rubber comprising of a step of combining natural rubber latex with ozone in an in situ ozonolyis reaction. In the process a mixture of natural rubber latex reacts with ozone in the in situ ozonolysis reaction until the weight average molecular weight of the mixture is lowered to a predetermined value.

In the process, natural rubber latex reacts with ozone to form the following ozonide compound (1) as an intermediate of the formula:

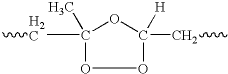

In the process, the predetermined value is not less than 1,000,000 weight average molecular weight.

In the process, functional groups comprising of ketone, characterized by the formula

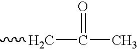

are attached to the chain ends of the modified natural rubber.

Alternatively, in the process, functional groups comprising of aldehyde, characterized by the formula

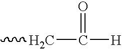

are attached to the chain ends of the modified natural rubber.

Alternatively, in the process, functional groups comprising of carboxyl, characterized by the formula

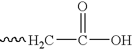

are attached to the chain ends of the modified natural rubber.

The process further comprises a step of removing impurities from natural rubber latex by using a separator prior to the in situ ozonolysis reaction process, and a step of removing water from the modified natural rubber by using a coagulant, formic acid or acetic acid subsequent to the in situ ozonolysis reaction process.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a diagram showing the mechanism of in situ ozonolysis reaction of natural rubber latex;

FIG. 2 is a schematic diagram showing the production process of the special-grade natural rubber;

FIG. 3 is a table showing the molecular weights and molecular weight distributions of the modified natural rubbers so called Innoprenes in comparison with those of the control;

FIG. 4 is FTIR spectra showing the increase of the peak of 1720 cm⁻¹ which represents the carbonyl functional groups of ozonolysed rubbers; and

FIG. 5 is a table showing the properties of the Innoprenes in comparison with those of STR XL, STR 5L and STR 20.

### DETAILED DESCRIPTION OF THE INVENTION

The present invention relates to the process of producing special-grade natural rubber using an in situ ozonolysis reaction of natural rubber latex. This new process aims to produce special-grade natural rubber having outstanding properties in which molecular weight, viscosity, consistency and purity are controllable.

One advantage of using in situ ozonolysis reaction to process natural rubber is the ability to obtain desirable weight-average molecular weight and viscosity of natural rubber latex in a controllable environment. Natural rubber molecules with appropriate lower weight-average molecular weight and viscosity are desirable because mastication process becomes unnecessary.

The advantages of the present inventive process allows for the production of special-grade natural rubber with superior consistency, lower weight-average molecular weight. In addition, this obtained special-grade natural rubber, i.e. Innoprene, provides the production process of rubber products in which Innoprene is used as a raw material lower production costs and energy consumption, shorter lead time and the elimination of mastication process. The inventive process also allows for the natural rubber to be easily mixed with other additives and fillers, providing for good distribution, increased efficiency and productivity.

The limitations of conventional methods of producing dry natural rubbers such as smoked rubber sheets and rubber blocks are overcome by eliminating the mastication process that is usually required prior to mixing of chemicals, additives and fillers. Moreover, the special-grade natural rubber is more conducive to mixture with chemicals, additives and fillers than conventionally processed rubber.

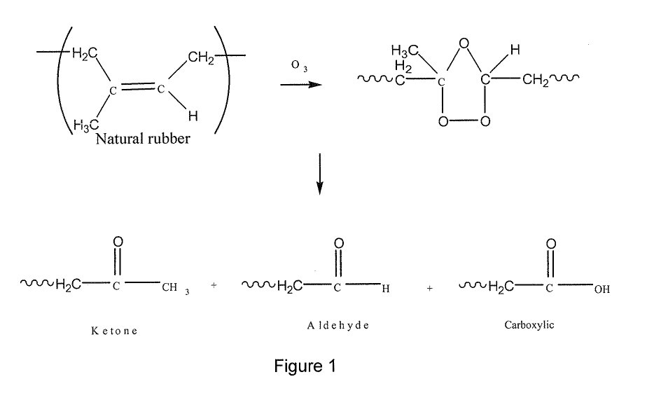

In an in situ ozonolysis reaction, ozone molecules react with the double bonds of natural rubber molecules. This reaction breaks the molecular chains to become shorter chains with functional groups of ketone, aldehyde and carboxyl attached at the chain ends (FIG. 1.). These functional groups present on the chain ends are believed to enhance the compatibility between some fillers and rubber.

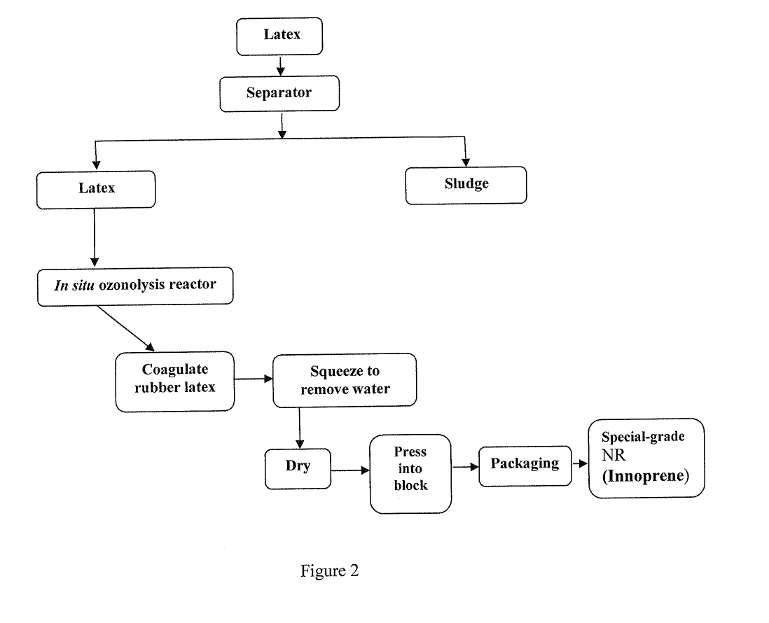

The raw materials used in the production process of special-grade natural rubber are natural rubber latex, ozone, and coagulant, formic acid or acetic acid. The first step in the process is to purify the natural rubber latex by using a separator or in order to remove sludge, dirt, and other impurities from the natural rubber latex. The second step involves the process of placing the purified natural rubber latex into the in situ ozonolysis reaction process until the weight-average molecular weight (Mw) is lowered to a predetermined value. (but not less than 1,000,000 by average). In the third step, water is separated and removed from the modified natural rubber latex by using a coagulant or acetic acid. In the fourth step, the natural rubber latex is then squeezed in order to remove any remaining water. The modified natural rubber latex is dried and subsequently pressed into a block shape. In the final step, the dry special-grade rubber blocks obtained are wrapped with the transparent plastic. The schematic production process of the special-grade natural rubber is shown in FIG. 2.

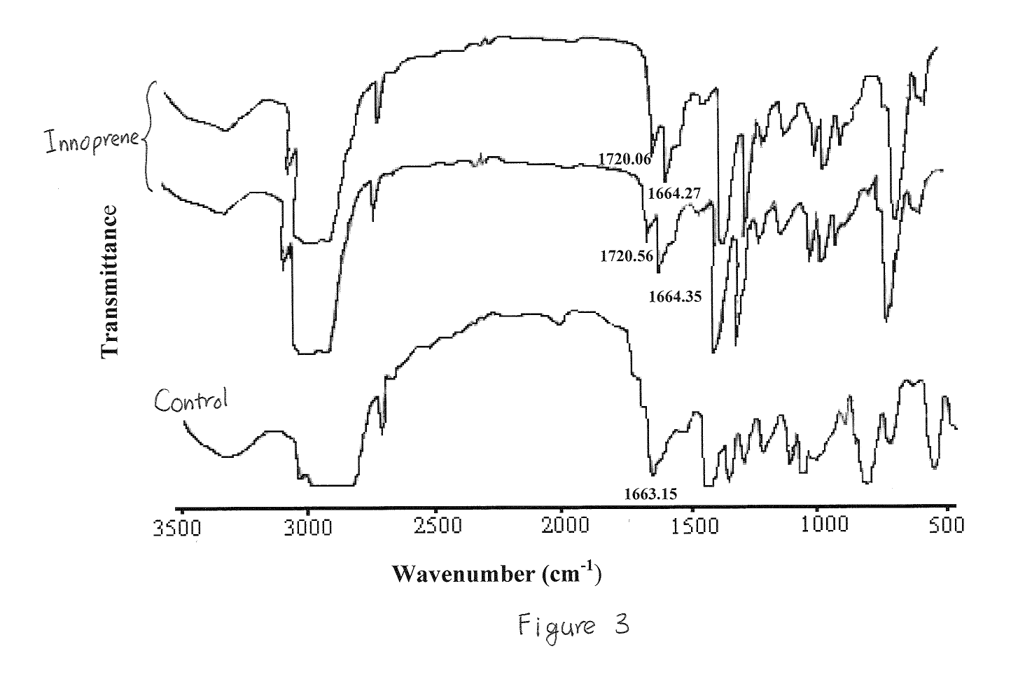

In situ ozonolysis reaction shows that higher ozone consumption provides lower weight-average molecular weight and viscosity. The inverse relationship between weight-average molecular weight and ozone consumption is evidenced by using Gel Permeation Chromatography (GPC), the results of which are shown in FIG. 3. FIG. 3 shows the reduction in weight-average molecular weight of special-grade natural rubber produced using the in situ ozonolysis reaction in comparison with that of the Control; i.e., rubber without using the in situ ozonolysis reaction.

The in situ ozonolysis reaction results in scission of the rubber molecule chains to shorten the chain lengths. Functional groups comprising of ketone, aldehyde and carboxylic acid are present at the chain ends of rubber molecules. The mechanism of the in situ ozonolysis reaction is shown in FIG. 1.

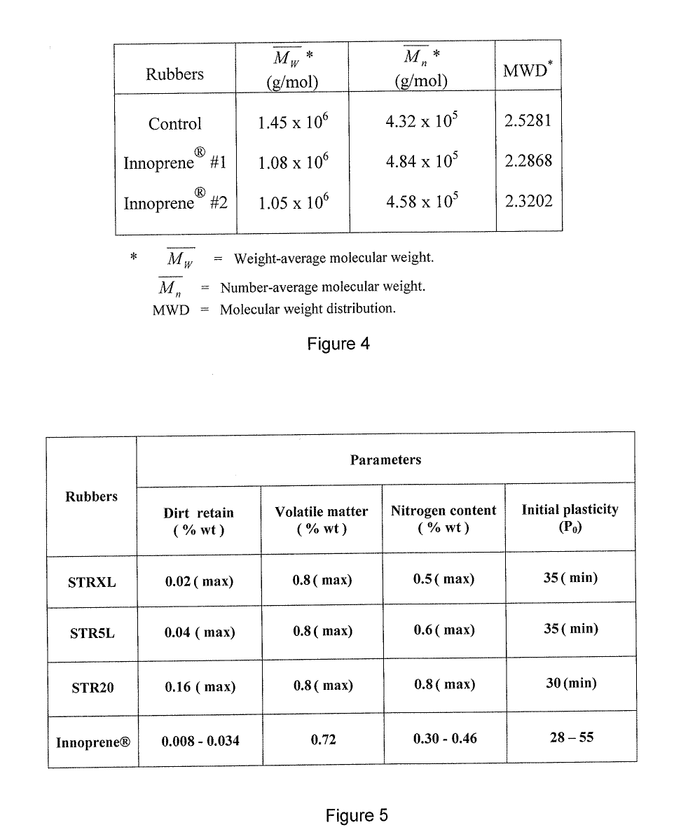

The presence of these functional groups after the ozonolysis reaction is evidenced by using Fourier Transform Infrared Spectroscopy (FTIR), the results of which are shown in FIG. 4. FIG. 4 shows the FTIR spectra of special-grade natural rubbers produced via in situ ozonolysis reaction, namely Innoprene #1 and Innoprene #2, in comparison with that of natural rubber produced without in situ ozonolysis reaction, namely Control. FIG. 3 shows a reduction of the peak at the wave number of 1663 cm⁻¹ which represents the alkene (C═C) of rubber molecules, evidencing the breaking of the double bonds between the carbon atoms resulting from the in situ ozonolysis reaction. FIG. 3 also shows an increase of the peak at the wave number of 1720 cm⁻¹ which represents the combined peak of carbonyl groups (C═O) of the ketone (R—C═O), aldehyde (R—HC═O) and carboxyl (R—HOC═O) of rubber molecules. This evidences the increase in the presence of the ketone, aldehyde, and carboxyl functional groups at the chain ends.

FIG. 5 shows the results of an analysis conducted by the Rubber Research Institute (Thailand). FIG. 5 compares the properties of different grades of conventionally produced natural rubber, such as STR XL, STR 5L, and STR 20, with the special-grade natural rubber produced by the inventive process. Impurity content such as dirt retained, volatile matter, and nitrogen content is measured as a percentage of total weight. In addition, initial plasticity is measured. The results show that the purity of special-grade natural rubber is in the similar range of grades STR5L and STRXL, which are the highest grades used in the rubber production industries. Moreover, special-grade natural rubber was found to have lower nitrogen content, which corresponds to the protein content in natural rubber. FIG. 5 confirms that the special-grade natural rubber produced by this inventive process has superior purity compared to the conventionally processed natural rubber in terms of protein content.

Below describes the distinguish properties of the special-grade natural rubber to commercial natural rubbers.
1. Constant viscosity due to the constant molecular weight which is controlled by the unique chemical process.
2. Transparency due to the high purified rubber obtained without any contamination of chemicals and metal ions.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A process of producing special-grade natural rubber comprising of:
a step of combining natural rubber latex with ozone in an in situ ozonolyis reaction, wherein a mixture of natural rubber latex reacts with ozone in the in situ ozonolysis reaction until the weight average molecular weight of the mixture is lowered to a predetermined value.

2. A process as recited in claim 1 wherein natural rubber latex reacts with ozone to form the following compound intermediate (1) of the formula

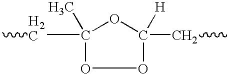

3. A process as recited in claim 2, wherein the predetermined value is not less than 1,000,000 weight average molecular weight.

4. A process as recited in claim 3 wherein functional groups comprising of ketone, characterized by the formula 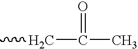
are attached to the chain ends of the modified natural rubber (2).

5. A process as recited in claim 4 further comprising a step of removing impurities from natural rubber latex by using a separator prior to the in situ ozonolysis reaction process.

6. A process as recited in claim 5 further comprising a step of removing water from the modified natural rubber (2) by using a coagulant, formic acid or acetic acid subsequent to the in situ ozonolysis reaction process.

7. A process as recited in claim 3 wherein functional groups comprising of aldehyde, characterized by the formula 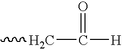
are attached to the chain ends of the modified natural rubber (3).

8. A process as recited in claim 7 further comprising a step of removing impurities from natural rubber latex by using a separator or prior to the in situ ozonolysis reaction process.

9. A process as recited in claim 8 further comprising a step of removing water from the modified natural rubber (3) by using a coagulant, formic acid or acetic acid subsequent to the in situ ozonolysis reaction process.

10. A process as recited in claim 3 wherein functional groups comprising of carboxyl, characterized by the formula 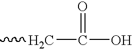
are attached to the chain ends of the modified natural rubber (4).

11. A process as recited in claim 10 further comprising a step of removing impurities from natural rubber latex by using a separator prior to the in situ ozonolysis reaction process.

12. A process as recited in claim 11 further comprising a step of removing water from the modified natural rubber (4) by using a coagulant, formic acid or acetic acid subsequent to the in situ ozonolysis reaction process.
